(19) United States
(12) Patent Application Publication
(10) Pub. No.: US 2010/0102593 A1
(43) Pub. Date: Apr. 29, 2010

(54) Interior Fitting for a Motor Vehicle

(75) Inventors: Jochen BISINGER, Esslingen (DE); Dieter RECKELS, Portland, OR (US); Holger SCHLEIFE, Stuttgart (DE); Kai SIEBER, Portland, OR (US)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/257,183

(22) Filed: Oct. 23, 2008

(51) Int. Cl. B60N 2/02

(52) U.S. Cl. 296/190.01; 296/65.01

(57) ABSTRACT

An interior fitting for a motor vehicle is equipped with a bunk and a seat. An element that can be moved into two different operating positions is provided. In a first operating position, the element extends the bunk, while, in the second operating position, the element forms a table for the seat.

### CROSS REFERENCE TO RELATED APPLICATIONS

Cross references are hereby made to commonly assigned U.S. patent applications Ser. Nos. ______, ______, and ______ (Attorney docket nos. 60630US, 60629US, and 60628US), filed on the same date as the present application.

### BACKGROUND AND SUMMARY OF THE INVENTION

This invention relates to an interior fitting for a motor vehicle that is particularly suitable for a driver's cab of a motor truck. Accordingly, the invention also relates to a motor truck with a driver's cab containing an interior fitting according to the invention. Besides having several seats, generally, at least one bunk is arranged in the driver's cab of a motor truck.

A multifunction element often proves itself advantageous when, as is often the case in motor vehicles, little space is available in the vehicle interior.

A multifunction seat is known from German publication DE 198 20 880 C1. The rear side of the backrest of this multifunction seat exhibits a work surface. This work surface can be made available for use when the backrest is folded down onto the seat cushion.

German document DE 44 25 549 C2 describes a multifunction panel that is used in the driver's cab of a motor truck. The panel can be utilized both as a tabletop and as a cover for a storage space.

German document DE 26 537 80 A1 describes a section of a co-driver's (passenger's) seat in a driver's cab of a motor truck that can be arranged under a bunk, situated transversely with respect to the longitudinal axis of the vehicle, while a remaining section can also be used by a person lying on the bunk.

One object of this invention is to expand the options for using components in an interior fitting for a motor vehicle.

This object is accomplished by way of an interior fitting for a motor vehicle including a bunk, a seat, and an element that can be moved into two different operating positions. The element extends a lying surface of the bunk in a first operating position, and is assigned as a table to the seat in a second operating position. A motor vehicle is equipped with such an interior fitting in its driver's cab.

In addition to a bunk and a seat, the interior fitting constitutes an element that can be moved into two different operating positions. In a first operating position, the element extends the lying surface of the bunk. In a second operating position, the element functions as a table by being assigned as such to a seat.

The element is moved into the first operating position when the vehicle occupants wish to rest or sleep. It is also possible to use the element as a table. Objects can then be placed on the element in the interior of the motor vehicle. For instance, the occupants can conveniently read a newspaper, study a book, or place a computer on the element and work or play on the computer in this position.

Preferably, the arrangement deviates from the otherwise standard concept that the bunk is situated transversely with respect to the longitudinal axis of the vehicle. Essentially, while lying in the defined position on the bunk, the vehicle occupant should be positioned along the longitudinal axis of the vehicle (with a possible deviation of up to 30°). In its first operating position, the element should then extend in the direction of the longitudinal axis of the vehicle with at least a part of the width of the bunk running transversely with respect to the longitudinal axis of the vehicle. In this way, the bunk, in the conventional position, does not take up an excessive amount of room in the direction of the longitudinal axis of the vehicle. As a result, the driver's cab of a motor truck equipped with this bunk need not be constructed with excessive length. This layout of the element in connection with the bunk is preferably enhanced in a way that the seat is designed as a swivel seat. In a predetermined position of the seat, in which a person sitting in the seat looks towards the rear in the longitudinal direction of the vehicle, that person can use the element in the second operating position as a table. In particular, the passenger's seat, simply rotated, can then be used, thus providing, together with the element, a table and chair or seat unit.

In order to increase convenience while using the element as a table, it is possible to provide a fold-out ledge that, in the second operating position of the element, can be pivoted in such a way that it functions as an end strip for the table, which in turn is a function of the element.

In precisely the same way, it is also possible to make available a pivoted screen which, in the second operating position of the element, can be pivoted over or on to this element (or with reference to the invention with the pivoted ledge, on to the pivoted ledge). This arrangement makes a screen available to the person sitting in the seat. A keyboard, a computer mouse, or other control elements, for example, can then be arranged on the table, thus allowing the screen to be used as computer monitor.

It is possible to arrange the element in such a way that it turns over when it is moved from the first into the second operating position and back. In the second operating position, a different side of the element than in the first operating position then faces upwards in the direction of the vertical axis of the vehicle. As a result, a particularly compact mechanism for changing the operating position can be realized. It is additionally possible to provide upholstery on the one side of the element, complementary to the corresponding upholstery on the bunk surface, and a smooth surface on the other side of the element, facilitating the functionality of the element as a table. Each side of the element can therefore be optimized to suit its respective function.

In a preferred layout, the seat can assume a folded position, arranged in the direction of the vertical axis of the vehicle at least partially under the element when the element takes up the first operating position. The reason for this arrangement is that the seat then does not obstruct the element when it is moved into the first operating position. The space otherwise taken up by the seat can be partially taken up by the element. Consequently, the interior of the motor vehicle (in particular the driver's cab of a motor truck) does not have to be constructed as deep as would otherwise be necessary if the main direction of the bunk were to run along the longitudinal axis of the vehicle.

The invention is described in more detail in the following with reference to the drawings.

### BRIEF DESCRIPTION OF THE DRAWINGS

FIG. 1 shows schematically an interior fitting for a motor vehicle with an element in a first operating position,

FIG. 2 shows schematically the interior fitting of FIG. 1 with the element in a second operating position,

FIGS. 3 and 4 illustrate how supplementary elements enhance the operating convenience in the second operating position,

FIGS. 5 to 7 illustrate how a seat can be folded down and placed under the element, and

FIG. 8 shows the arrangement created in this way.

### DETAILED DESCRIPTION OF THE INVENTION

A bunk 14 is arranged in an interior fitting, identified as a whole by reference number 10, in a driver's cab of a motor truck, illustrated through a doorway 12. A seat 16 is also provided. The bunk 14 is longer along the longitudinal axis A of the vehicle than it is wide along the transverse axis B. This situation applies at least when an element 18 that serves as an extension to the bunk 14 is added to the bunk 14. In this case, the element 18 is in a first operating position, in which it is arranged at the same level as the bunk. A surface 20 of the element 18 faces upwards in the direction of the vertical axis C of the vehicle, whereby the surface 20 is upholstered in exactly the same way as the bunk 14.

The element 18 can be moved into a second operating position that is shown in FIG. 2. To move it into this second operating position, the element 18 is folded up as indicated by the arrow 22 while also being turned at the same time. A suitable connecting link 24 serves as a guide. As a result of the rotation, the surface 26 of the element 18 now faces upwards. This surface is not upholstered; rather, it is smooth so that it can be used as a tabletop. The seat 16 is the co-driver's (passenger's) seat which, compared to its normal position while driving the motor truck, is rotated by 180°. As a result, a person sitting in the seat 16 looks towards the rear in the direction of the longitudinal axis A of the vehicle. This person can use the element 18 in the second operating position as a table in accordance with FIG. 2.

As indicated by arrow 28, an additional ledge 30 can be folded out of a wall area 32 in the interior fitting 10 so that it closes off, flush, the element 18, in particular on surface 26, thus serving as an end finishing strip. Furthermore, a carrier 34, which supports a screen 36, can also be pivoted as indicated by arrow 38 in FIG. 4. The carrier can be folded out on to the ledge 30 so that an arm 40 of the carrier is aligned flush with the ledge 30. The screen 36 can be rotated in the carrier in such a way that it is possible to view the screen from the seat 16. A small computer, for example, can now be placed on the element 18 and connected to the screen 36 so that it serves as the monitor for the small computer.

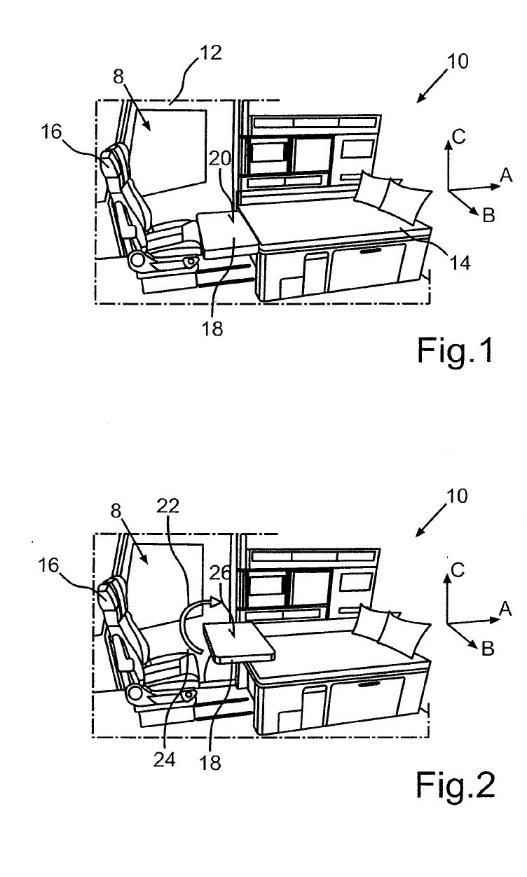

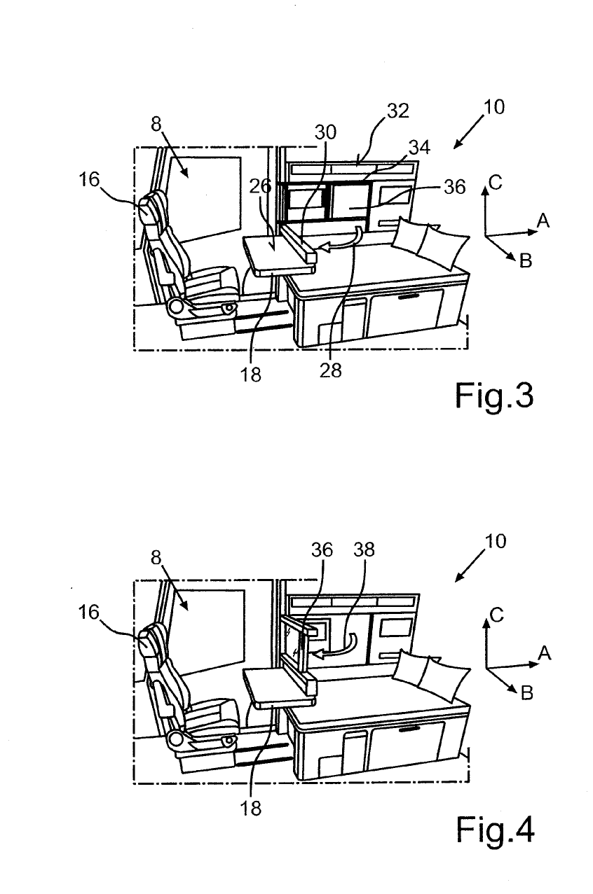

The element 18 can therefore be used both as the extension to the bunk (FIG. 1) and as a table (FIGS. 2 to 4).

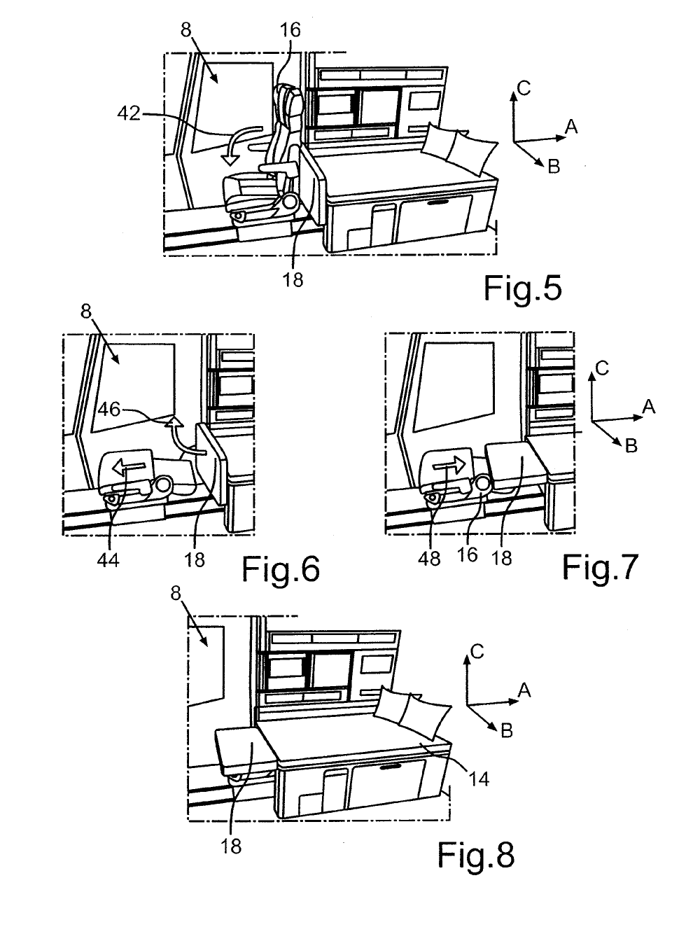

As illustrated in FIG. 5, the element 18 is folded in a third position, which is not an operating position. FIG. 5 shows the seat 16 in the standard position for driving in the motor truck. The seat 16 is now folded down as indicated by the arrow 42 by lowering the backrest in the direction towards the seat cushion. The backrest is then folded together as indicated by arrow 44. The element 18 can now be raised as indicated by arrow 46. The folded seat 16 can be pushed under the element 18 as indicated by the arrow 48, thus creating the situation illustrated in FIG. 8. This arrangement differs from the situation shown in FIG. 1 in that the seat 16 is no longer in the way. In the situation illustrated in FIG. 8, the element 18 is in its first operating position and serves as an extension to the bunk 14.

Although modifications and changes may be suggested by those skilled in the art, it is the intention of the inventor to embody within the patent warranted hereon all changes and modifications as reasonably and properly come within the scope of his contribution to the art.

We claim:

1. An interior fitting for a motor vehicle comprising:
a bunk,
a seat, and
an element that can be moved into two different operating positions,
wherein said element extends a lying surface of the bunk in a first operating position and is assigned as a table to the seat in a second operating position.

2. The interior fitting in accordance with claim 1, wherein the element, in the first operating position, extends, in the direction of a longitudinal axis of the vehicle, at least a part of the width of bunk running transversely with respect to the longitudinal axis of the vehicle, wherein the seat is a swivel seat, and wherein, in a predetermined position of the seat, in which a person sitting in the seat looks towards the rear in the direction of the longitudinal axis of the vehicle, that person can use the element as a table in the second operating position.

3. The interior fitting in accordance with claim 1, further comprising a pivoted ledge, which, in the second operating position of the element, can be swivelled into such a position that it serves as an end finishing strip to the element functioning as a table.

4. The interior fitting in accordance with claim 1, further comprising a pivoted screen that can be swivelled over or onto the element in the second operating position of the element.

5. The interior fitting in accordance with claim 1, wherein, in the second operating position, another side of the element than in the first operating position faces upwards in the direction of the vertical axis of the vehicle.

6. The interior fitting in accordance with claim 5, wherein one side of the element exhibits upholstery and another side of the element has a smooth surface.

7. The interior fitting in accordance with claim 1, wherein the seat can be folded and arranged in the direction of the vertical axis of the vehicle at least partially under the element when the element assumes the first operating position.

8. A motor truck with a driver's cab equipped with an interior fitting according to claim 1.

9. The interior fitting according to claim 1, wherein said interior fitting is for a driver's cab of a motor truck.

10. A motor truck with a driver's cab equipped with an interior fitting according to claim 2.

11. A motor truck with a driver's cab equipped with an interior fitting according to claim 3.

12. A motor truck with a driver's cab equipped with an interior fitting according to claim 4.

13. A motor truck with a driver's cab equipped with an interior fitting according to claim 5.

14. A motor truck with a driver's cab equipped with an interior fitting according to claim 6.

15. A motor truck with a driver's cab equipped with an interior fitting according to claim 7.
